(19) United States
(12) Patent Application Publication
(10) Pub. No.: US 2012/0329513 A1
(43) Pub. Date: Dec. 27, 2012

(54) ANTENNA DIVERSITY SYSTEM USING ACTIVE ANTENNA

(75) Inventors: Jong-Ho Jung, Yongin (KR); Byong-Nam Kim, Bucheon (KR)

(73) Assignee: ACE TECHNOLOGIES CORPORATION, Incheon (KR)

(21) Appl. No.: 13/125,389

(22) PCT Filed: Oct. 19, 2009
(86) PCT No.: PCT/KR09/06027

§ 371 Date: Apr. 21, 2011

(30) Foreign Application Priority Data
Oct. 21, 2008 (KR) 10-2008-0103336

(51) Int. Cl. H04W 88/06

(52) U.S. Cl. 455/552.1

(57) ABSTRACT

An antenna diversity system using an active antenna is disclosed. The disclosed system may include: a first antenna configured to transmit and receive a signal of a first frequency band; a second antenna configured to transmit and receive a signal of a second frequency band; and an active circuit unit implemented by active elements. In a first mode, the second antenna is operated as a passive antenna, and in a second mode, the second antenna is electrically connected to the active circuit unit and operated as an active antenna. The disclosed diversity system has the advantages of using a diversity antenna without increasing the size of a terminal, and of using an active antenna as a diversity antenna.

### TECHNICAL FIELD

The present invention relates to an antenna, more particularly to an antenna diversity system using an active antenna.

### BACKGROUND ART

Recently there is a demand for the ability to receive mobile communication services of different frequency bands through one mobile communication terminal, even as mobile communication terminals become smaller and lighter. There is a demand for terminals that are able to use signals of multiple bands simultaneously, for mobile communication services using a variety of frequency bands such as the CDMA service of the 824-894 MHz band and the PCS service of the 1750-1870 MHz, which have been commercialized in Korea, the CDMA service of the 832-925 MHz band, which has been commercialized in Japan, the PCS service of the 1850-1990 MHz band, which has been commercialized in the U.S., the GSM service of the 880-960 MHz band, which has been commercialized in Europe and China, and the DCS service of the 1710-1880 MHz band, which has been commercialized in parts of Europe. Besides these, there is also a demand for composite terminals that are able to use services such as Bluetooth, ZigBee, wireless LAN, GPS, etc.

Such convergence terminals offering all services of various frequency bands form the main trend in mobile communication, and along with this, miniaturization of terminals continues to be in demand.

With this demand for services of multiple bands, there inevitably arose the problem of a need for a large number of antennae and, accordingly, the need for a terminal of a large size.

At the same time, in the field of wireless communication, especially the field of mobile communication, diversity antennae are used for the ease of high-speed fading caused by multipath signal propagation.

A diversity antenna is used for stable reception of signals being of the same signal but having different fading characteristics; however, when using a diversity antenna, the problem arises of a need for a large number of antennae and for a terminal of a large size.

### DISCLOSURE

### Technical Problem

To resolve the problem addressed above, an aspect of the invention provides a diversity antenna system using an active antenna that can use a diversity antenna without increasing the size of a terminal.

Another purpose of the present invention is to provide a diversity antenna system that uses an active antenna as a diversity antenna.

Other purposes of the present invention can be derived through the embodiments below by those skilled in the related art.

### Technical Solution

To achieve the objective above, an aspect of the invention provides an antenna diversity system using an active antenna that includes a first antenna configured to transmit and receive a signal of a first frequency band; a second antenna configured to transmit and receive a signal of a second frequency band; and an active circuit unit implemented by active elements. In a first mode, the second antenna is operated as a passive antenna, and in a second mode, the second antenna is electrically connected to the active circuit unit and operated as an active antenna.

When it is operated as an active antenna in the second mode, the resonance band of the second antenna is the first frequency band.

In the second mode, the second antenna is operated as a diversity antenna for the first frequency band.

The first frequency band may be a mobile service frequency band and the second frequency band may be a Bluetooth band.

Another aspect of the invention provides an antenna diversity system using an active antenna that includes a first antenna configured to transmit and receive signals of a first frequency band; a first frequency RF circuit unit configured to process signals of the first frequency band; a second antenna configured to transmit signals of a second frequency band; a second frequency RF circuit unit configured to process signals of the second frequency band; an active circuit unit implemented by active elements; and a switching unit configured to switch connections between the second antenna and the active circuit unit and between the second antenna and the second frequency RF circuit unit.

### Advantageous Effects

An embodiment of the present invention offers the advantages of using a diversity antenna without increasing the size of a terminal, and of using an active antenna as a diversity antenna.

### BRIEF DESCRIPTION OF DRAWINGS

FIG. 1 is a drawing illustrating a conceptual diagram of a diversity antenna system of a mobile communication terminal using an active antenna according to an embodiment of the present invention.

FIG. 2 is a drawing illustrating an antenna diversity system of a mobile communication terminal configured to use an antenna of a Bluetooth band as a diversity antenna for a CDMA band.

FIG. 3 is a drawing illustrating a feeding method for a second antenna coupled with an active circuit unit according to an embodiment of the present invention.

FIG. 4 is a graph illustrating the VSWR of a second antenna when an active circuit unit of the present invention is coupled to it, and the VSWR of a second antenna when an active circuit unit is not coupled to it, but rather, it is operated as a passive antenna.

### MODE FOR INVENTION

A diversity antenna system of a mobile communication terminal using an active antenna according to an embodiment of the invention will be described below in more detail with reference to the accompanying drawings.

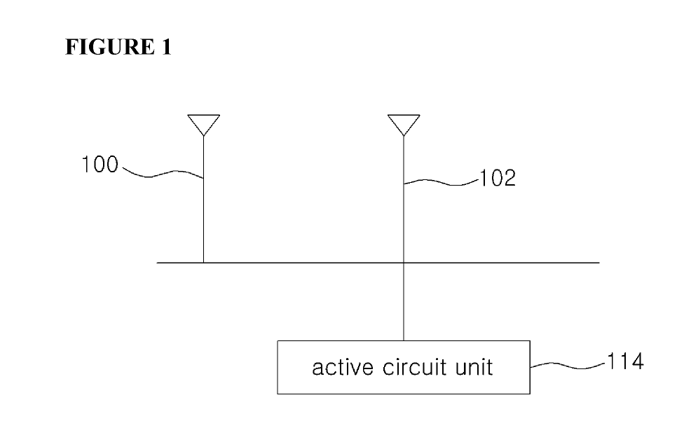

FIG. 1 is a drawing illustrating a conceptual diagram of a diversity antenna system of a mobile communication terminal using an active antenna according to an embodiment of the present invention.

Referring to FIG. 1, an antenna diversity system of a mobile communication terminal using an active antenna according to an embodiment of the present invention comprises a first antenna 100, a second antenna 102, and an active circuit unit 114 coupled with the second antenna.

The first antenna 100 is an antenna for receiving signals of a preset first frequency band. The first antenna includes both an internally fitted antenna and an externally fitted antenna. The first antenna transmits and receives signals of the first frequency band. According to an embodiment of the present invention, the first antenna may be an antenna that transmits and receives ordinary mobile communication frequency signals such as CDMA or GSM signals.

The second antenna 102 is placed at a designated distance from the first antenna 100. The second antenna 102 is operated as an antenna for receiving signals of a preset second frequency band in the first mode. The second antenna also may include both an internally fitted antenna and an externally fitted antenna. According to an embodiment of the present invention, the second antenna may be an antenna that transmits and receives signals of a Bluetooth band in the first mode.

In other words, in the first mode, the first antenna 100 operates as an antenna for transmitting and receiving signals of the first frequency band, and the second antenna 102 operates as an antenna for transmitting and receiving signals of the second frequency band. The first frequency band is a lower frequency band than the second frequency band, and the radiator of the first antenna 100 is larger in size than that of the second antenna 102.

In the second mode, the second antenna 102 is electrically connected to the active circuit unit 114 and operates as an active antenna. An active antenna is a type of antenna that includes an active element, and its characteristics and performance is controlled by the active element.

The second antenna 102 may operate as an antenna that resonates at a band lower than the length of the radiator if it is operated as an active antenna.

The active circuit unit 114 includes an amplification module, and the amplification module has the functions of performing impedance matching such that the antenna forms a resonance point in a lower band than when the antenna is operated as a passive antenna, and of amplifying weak signals.

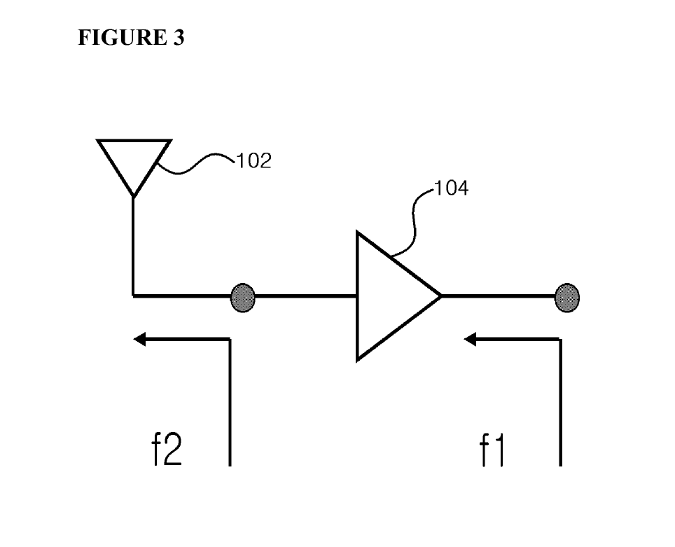

FIG. 3 is a drawing illustrating a feeding method for a second antenna coupled with an active circuit unit according to an embodiment of the present invention.

Referring to FIG. 3, the first frequency signals or the second frequency signals are fed to the second antenna 102, and through switching one of them are fed or received through the second antenna.

The second frequency signals f2 are fed to the front end of the active circuit unit 114, thus not being affected by the active circuit unit 114, and the second antenna operates as a passive antenna. The first frequency signals f1 are input to the active circuit unit 114 and fed to the second antenna 102. Here, the active circuit unit 114 pulls down the resonance frequency of the second antenna through impedance conversion, and amplifies signals.

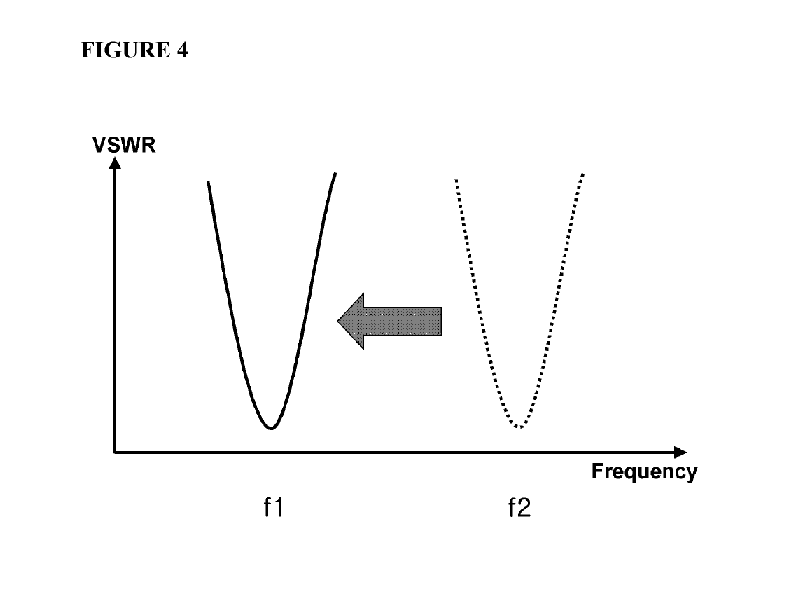

FIG. 4 is a graph illustrating the VSWR of a second antenna when an active circuit unit of the present invention is coupled to it, and the VSWR of a second antenna when an active circuit unit is not coupled to it, but rather, it is operated as a passive antenna.

Referring to FIG. 4, it can be seen that, in the case of the second antenna not being coupled to the active circuit unit, the resonance point is formed in a comparatively high band, but in the case of its being coupled to the active circuit unit, the resonance point is formed in a low frequency band.

According to a preferred embodiment of the present invention, the second antenna 102 operating as an active antenna in the second mode has a resonance band formed in the first frequency band. In other words, the second antenna 102 operates in the same frequency band as the first antenna by means of the active circuit unit 114, and operates as a diversity antenna for the first frequency band.

According to the related art, a separate diversity antenna was required for diversity implementation, but according to the present invention, an antenna used in a different service band is used as a diversity antenna through implementation of an active antenna as a diversity antenna, thus a separate antenna is not required for diversity implementation, and antenna diversity may be implemented in small size in a mobile communication terminal.

Switching of the first and second modes may be implemented by a variety of means; for example, switching of the first and second modes may be accomplished by an ordinary switching method.

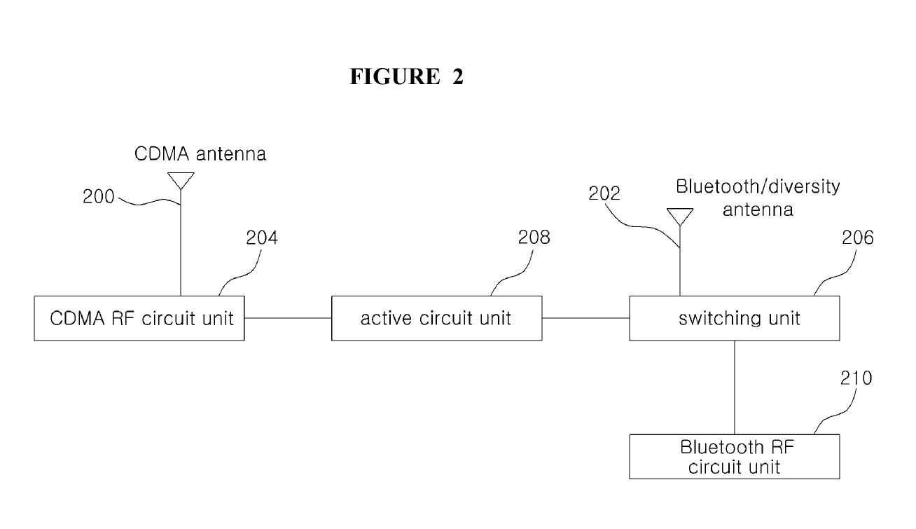

FIG. 2 is a drawing illustrating an antenna diversity system of a mobile communication terminal configured to use an antenna of a Bluetooth band as a diversity antenna for a CDMA band.

In FIG. 2, an explanation will be presented for operating a Bluetooth antenna as a diversity antenna for a CDMA band when it is operated as an active antenna; however, those of ordinary skill in the art will understand that this is not intended to limit the present invention to particular modes of practice, and that embodiments of the present invention may be utilized for various frequency bands.

Referring to FIG. 2, an antenna diversity system according to an embodiment of the present invention comprises: a CDMA antenna 200; a Bluetooth/diversity antenna 202; a CDMA RF circuit unit 204; a switching unit 206; an active circuit unit 208; and a Bluetooth RF circuit unit 210.

The CDMA antenna 200 transmits and receives signals of a CDMA frequency band. According to an embodiment of the present invention, a micro-stream patch antenna may be used as a CDMA antenna, and of course, an externally fitted antenna may also be used.

The CDMA RF circuit unit 204 is electrically connected to the CDMA antenna 200, and has the function of feeding CDMA modulation/demodulation and CDMA RF signals to the CDMA antenna 200.

The switching unit 206 performs the switching function of electrically connecting the Bluetooth/diversity antenna 202 to the Bluetooth RF circuit unit 208 or the active circuit unit 206 according to the mode.

For example, if a user wants to use the Bluetooth function of a mobile communication terminal, the switching unit 206 electrically connects the Bluetooth/diversity antenna to the Bluetooth RF circuit unit 210, and if the user wants to have a vocal communication through the mobile communication terminal, the switching unit 206 electrically connects the Bluetooth/diversity antenna 202 to the active circuit unit 208.

Although not illustrated in FIG. 2, a controller (not pictured) that controls the connecting of the switching unit 206 according to the mode may be included additionally.

In the mode for a user's having vocal communication, the Bluetooth/diversity antenna 202 is electrically connected to the active circuit unit 208, and the Bluetooth/diversity antenna 202 operates as a diversity antenna for the CDMA band.

According to an embodiment of the present invention, the active circuit unit 208 may include an amplification module for amplifying the signals with lumped elements configured to allow the Bluetooth/diversity antenna to accomplish matching in the CDMA band, and the amplification module may be implemented by transistors.

The physical length of the Bluetooth/diversity antenna 202 is established in correspondence with the Bluetooth frequency band; however, if it is electrically connected to the active circuit unit 208, resonance frequency is lowered due to the change in the output impedance brought on by the operation of the active element of the active circuit unit, and as already described, the active circuit unit 208 is set so that the Bluetooth/diversity antenna 202 resonates in the CDMA frequency band.

According to an embodiment of the present invention, the Bluetooth/diversity antenna 202 may be a Bluetooth chip antenna.

In the case of the user using Bluetooth service, the Bluetooth/diversity antenna 202 is electrically connected to the Bluetooth RF circuit unit 210, and the Bluetooth/diversity antenna operates as an ordinary passive antenna.

As described above, according to a preferred embodiment of the present invention, one antenna may be used for two bands, through connecting the active circuit unit and the antenna by means of switching.

In addition, there is the advantage of using an antenna used in a different band as a diversity antenna without coupling a separate diversity antenna.

While the spirit of the invention has been described in detail with reference to particular embodiments, it is to be appreciated that those skilled in the art can change or modify the embodiments without departing from the scope and spirit of the invention as set forth in the claims below.

1. An antenna diversity system using an active antenna, the antenna diversity system comprising:
a first antenna configured to transmit and receive a signal of a first frequency band;
a second antenna configured to transmit and receive a signal of a second frequency band; and
an active circuit unit implemented by active elements;
wherein the second antenna operates as a passive antenna in a first mode, and the second antenna is electrically connected to the active circuit unit to operate as an active antenna in a second mode.

2. The antenna diversity system using an active antenna according to claim 1, wherein the second antenna has a resonance band substantially equal to the first frequency band when operating as an active antenna in the second mode.

3. The antenna diversity system using an active antenna according to claim 1, wherein the second antenna operates as a diversity antenna for the first frequency band in the second mode.

4. The antenna diversity system using an active antenna according to claim 1, wherein the first frequency band is a mobile communication service frequency band and the second frequency band is a Bluetooth band.

5. An antenna diversity system using an active antenna comprising:
a first antenna configured to transmit and receive signals of a first frequency band;
a first frequency RF circuit unit configured to process signals of the first frequency band;
a second antenna configured to transmit signals of a second frequency band;
a second frequency RF circuit unit configured to process signals of the second frequency band;
an active circuit unit implemented by active elements; and
a switching unit configured to switch connections between the second antenna and the active circuit unit and between the second antenna and the second frequency RF circuit unit.

6. The antenna diversity system using an active antenna according to claim 5, wherein the second antenna operates as an active antenna and has a resonance band substantially equal to the first frequency band, when the second antenna is connected to the active circuit unit by the switching unit.

7. The antenna diversity system using an active antenna according to claim 6, wherein the second antenna configured to resonate in the first frequency band operates as a diversity antenna for the first antenna.
